(19) United States
(12) Patent Application Publication
(10) Pub. No.: US 2026/0233750 A1
(43) Pub. Date: Aug. 13, 2026

(54) INFORMATION PROCESSING DEVICE

(71) Applicants: TOYOTA JIDOSHA KABUSHIKI KAISHA, Toyota-shi (JP); DENSO TEN Limited, Kobe (JP)

(72) Inventors: Zhenqin SHI, Tokyo (JP); Akira TOYOTA, Kobe-shi (JP); Ryosuke MATSUOKA, Kobe-shi (JP); Koichiro TAKEUCHI, Nagoya-shi (JP)

(73) Assignees: TOYOTA JIDOSHA KABUSHIKI KAISHA, Toyota-shi (JP); DENSO TEN Limited, Kobe (JP)

(21) Appl. No.: 19/434,742

(22) Filed: Dec. 29, 2025

(30) Foreign Application Priority Data
Jan. 24, 2025 (JP) 2025-010900

(51) Int. Cl. B60W 50/14; B60K 35/28; B60W 30/14; G06V 20/58

(52) U.S. Cl. CPC B60W 50/14; B60K 35/28; B60W 30/146; G06V 20/58; B60K 2360/176; B60K 2360/566; B60W 2420/403; B60W 2554/4042; B60W 2556/10; G06V 2201/07; G06V 2201/08

(57) ABSTRACT

An information processing device includes: a communication unit configured to communicate with an in-vehicle device; and a control unit configured to, when a travel history of a vehicle indicates that the vehicle passes in a vicinity of a target object, acquire an image captured in the vicinity of the target object from the in-vehicle device of the vehicle, send information indicating a state of the target object to a terminal device, and cause the terminal device to output the information.

### CROSS-REFERENCE TO RELATED APPLICATION

This application claims priority to Japanese Patent Application No. 2025-010900 filed on January 24, 2025. The disclosure of the above-identified application, including the specification, drawings, and claims, is incorporated by reference herein in its entirety.

### BACKGROUND

### 1. Technical Field

The present disclosure relates to an information processing device.

### 2. Description of Related Art

Image capturing means for capturing images of a vicinity of a vehicle when an accident etc. occurs in a vehicle, such as a driving recorder, is known for investigating the scene in the vicinity after the accident. For example, Japanese Unexamined Patent Application Publication No. 2022-127838 (JP 2022-127838 A) discloses a technology for stringently selecting and collecting high-accuracy images from among a large number of similar images captured by a plurality of vehicles.

### SUMMARY

When a target image is acquired from a large number of captured images, the load of image processing is enormous. Therefore, there is room for improvement in efficiency when acquiring a target captured image from images captured by a vehicle.

The following discloses an information processing device etc. that can more efficiently acquire a target captured image from images captured by a vehicle.

The information processing device of the present disclosure includes: a communication unit configured to communicate with a vehicle; and a control unit configured to, when a travel history of the vehicle indicates that the vehicle passes in a vicinity of a target object, acquire an image captured in the vicinity of the target object from the vehicle, and output information indicating a state of the target object.

With the information processing device etc. of the present disclosure, it is possible to more efficiently acquire a target captured image from images captured by a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an example of a configuration of an information providing system; and

FIG. 2 is a sequence diagram showing an example of operation procedures of the information providing system.

### DETAILED DESCRIPTION OF EMBODIMENTS

An embodiment will be described below with reference to the drawings.

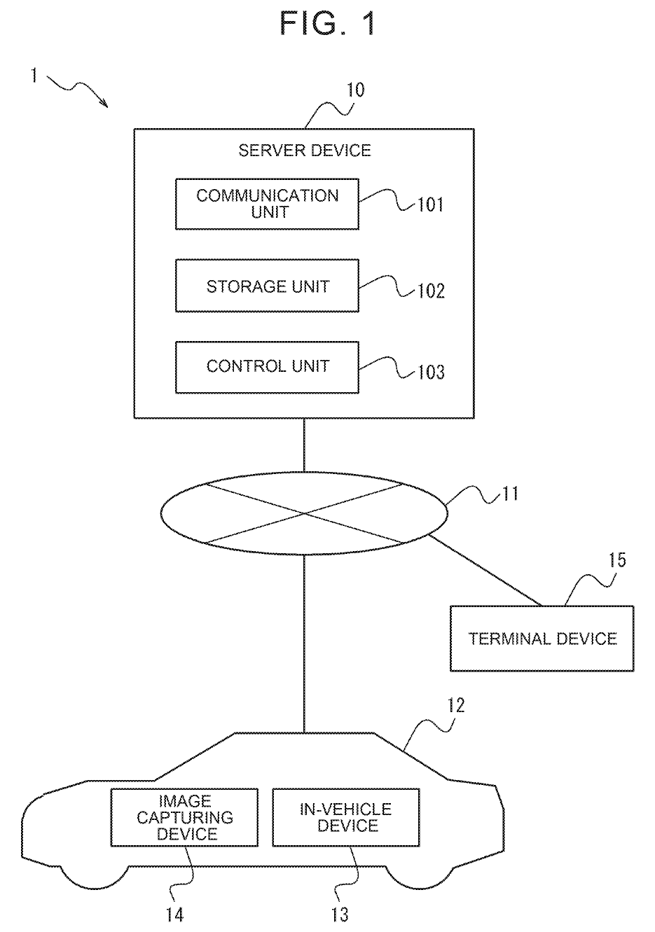

FIG. 1 is a diagram showing an example of a configuration of a vehicle control system according to an embodiment. The vehicle control system 1 includes one or more server devices 10, in-vehicle devices 12 mounted on one or more vehicles 13, and one or more terminal devices 15. These devices are connected to each other via a network 11 to communicate information with each other. The server device 10 corresponds to an "information processing device" in the present embodiment, and is, for example, one or more server computers that belong to a cloud computing system or any other computing system and function as a server that implements various functions. The vehicle 13 may be a passenger car, a commercial vehicle, an internal combustion engine vehicle, a hybrid electric vehicle, a plug-in hybrid electric vehicle, etc. The in-vehicle device 12 is a computer that has a communication function and an information processing function, and that controls operations of the vehicle 13 and operations of an image capturing device 14 mounted on the vehicle 13. The image capturing device 14 is a so-called driving recorder device, and includes a digital camera positioned to capture images of the interior and exterior of the vehicle 13, and a control circuit for the digital camera. The terminal device 15 is an information processing device having a communication function. Examples thereof include a personal computer and a smartphone. The network 11 may be, for example, a mobile communication network, the Internet, an ad-hoc network, a local area network (LAN), a metropolitan area network (MAN), any other network, or any combination thereof.

The server device 10 includes a communication unit 101 and a control unit 103. The communication unit 101 communicates with the vehicle 13. When the travel history of the vehicle 13 indicates that the vehicle 13 passes in the vicinity of a target object, the control unit 103 acquires an image captured in the vicinity of the target object from the vehicle 13 and outputs information indicating the state of the target object. The target object is, for example, a structure whose deterioration degree needs to be monitored over time, and includes an architectural structure such as a building or a roadside installation such as a sign. In the vehicle 13, the in-vehicle device 12 communicates with the server device 10 and controls the image capturing device 14 to acquire captured images. Then, the server device 10 sends the captured images acquired from the vehicle 13 to the terminal device 15. By continuously performing such operations, an operator who acquires the captured images using the terminal device 15 can monitor the appearance of the target object in the captured images over time. The server device 10 selects a vehicle 13 that is highly likely to travel in the vicinity of the target object based on the travel histories of a plurality of vehicles 13, and causes the vehicle 13 to send images captured in the vicinity of the target object. Therefore, it is possible to provide the operator with captured images that are highly likely to include the target object without requiring processing such as extraction of the target object from the captured images collected from many other vehicles 13. Thus, it is possible to more efficiently acquire the target captured image from the images captured by the vehicle.

An example of the configuration of the server device 10 will be described. The server device 10 includes a storage unit 102 in addition to the communication unit 101 and the control unit 103. The server device 10 may be one computer, or may be constituted by two or more computers that are connected to communicate information and perform coordinated operations. When the server device 10 is constituted by two or more computers, the configuration shown in FIG. 1 is distributed in the two or more computers as appropriate.

The communication unit 101 includes one or more communication interfaces. Examples of the communication interface include a LAN interface. The communication unit 101 receives information to be used for operations of the control unit 103, and transmits information obtained through the operations of the control unit 103. The server device 10 is connected to the network 11 by the communication unit 101, and communicates information with the in-vehicle device 12, the terminal device 15, etc. via the network 11.

The storage unit 102 includes, for example, one or more semiconductor memories, one or more magnetic memories, one or more optical memories, or a combination of at least two of these memories to function as a main storage device, an auxiliary storage device, or a cache memory. The semiconductor memory is, for example, a random access memory (RAM) or a read-only memory (ROM). The RAM is, for example, a static RAM (SRAM) or a dynamic RAM (DRAM). The ROM is, for example, an electrically erasable programmable ROM (EEPROM). The storage unit 102 stores information to be used for operations of the control unit 103 and information obtained through the operations of the control unit 103.

The control unit 103 includes one or more processors, one or more dedicated circuits, or a combination thereof. The processor is a general-purpose processor such as a central processing unit (CPU), or a dedicated processor specialized for specific processing, such as a graphics processing unit (GPU). The dedicated circuit is, for example, a field-programmable gate array (FPGA) or an application-specific integrated circuit (ASIC). The control unit 103 performs information processing related to operations of the server device 10 while controlling each unit of the server device 10.

The functions of the server device 10 are implemented by the processor of the control unit 103 executing a control program. The control program is a program that causes a computer to perform the steps included in the operations of the server device 10 and thus causes the computer to implement the functions corresponding to the steps. That is, the control program is a program that causes the computer to function as the server device 10. Part or all of the functions of the server device 10 may be implemented by the dedicated circuit of the control unit 103. The control program may be stored in a non-transitory recording or storage medium that can be read by the server device 10, and the server device 10 may read the control program from the medium.

The configuration of the in-vehicle device 12 will be described. The in-vehicle device 12 is constituted by one or more control devices, a communication device, and other devices. The control device includes a microcomputer such as an electronic control unit (ECU). The control device includes a user interface and can receive information input by user operations and output information obtained by information processing. The communication device includes a data communication module (DCM) etc. and is connected to the network 11 by mobile communications to communicate information with the server device 10 via the network 11. The in-vehicle device 12 and various parts of the vehicle 13 are connected to each other to communicate information with each other via an in-vehicle network conforming to a standard such as a controller area network (CAN). The in-vehicle device 12 controls operations of the vehicle 13 by acquiring detection results from sensors for vehicle speed, acceleration, etc. of the vehicle 13 and controlling various actuators that perform the operations of the vehicle 13, and also controls operations of the image capturing device 14 to acquire captured images from the image capturing device 14. The in-vehicle device 12 includes one or more global navigation satellite system (GNSS) receivers, and acquires position information of the vehicle 13. The in-vehicle device 12 may include, as a part thereof, an information processing device such as an automotive navigation system, a smartphone, or a tablet terminal.

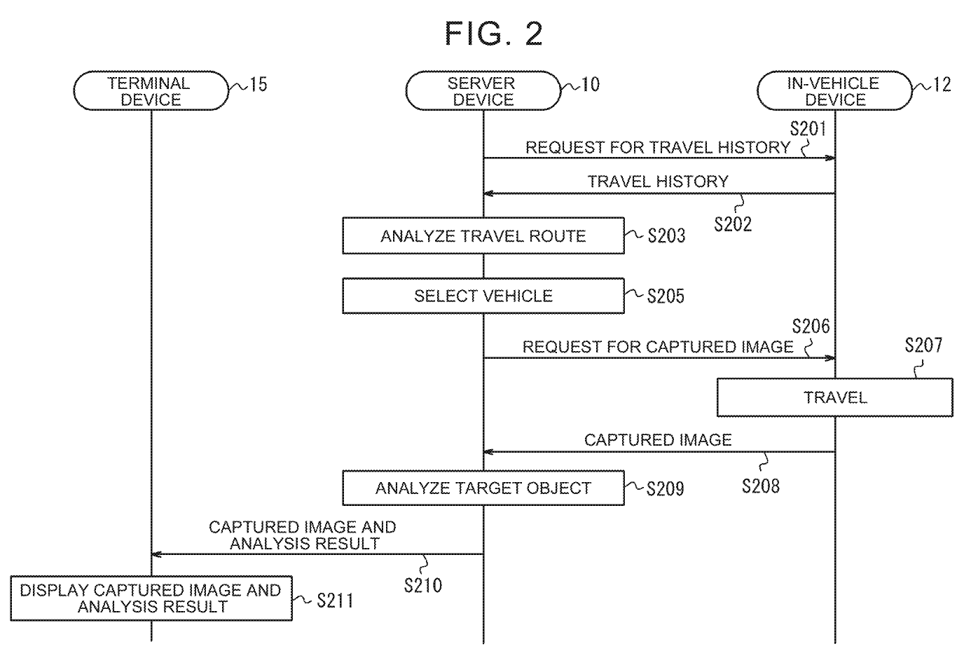

FIG. 2 is a sequence diagram illustrating operation procedures of the vehicle control system 1 according to the present embodiment. FIG. 2 shows procedures for the coordinated operations of the server device 10, the in-vehicle device 12 of the vehicle 13, and the terminal device 15. The steps related to various types of information processing of the server device 10 in FIG. 2 are performed by the control unit 103. The steps related to exchange of various types of information by the server device 10 are performed by the control unit 103 exchanging information via the communication unit 101. In the server device, information to be processed, referred to, or exchanged by the control unit 103 is stored in the storage unit 102 as appropriate. The operations of the vehicle 13 according to the present embodiment are implemented by the operations of the in-vehicle device 12 in FIG. 2.

The procedures in FIG. 2 may be performed daily or any number of times per day. The procedures in FIG. 2 may be performed before the vehicle 13 starts traveling, or may be performed while the vehicle 13 is traveling.

In S201, the server device 10 requests a travel history from the in-vehicle device 12. The server device 10 prestores, for example, identification information of each of the in-vehicle devices 12 necessary for exchanging information with one or more of cooperating in-vehicle devices 12. The server device 10 sends information for requesting the travel history to each in-vehicle device 12 based on the identification information.

In S202, the in-vehicle device 12 sends information on the travel history to the server device 10 in response to the request from the server device 10. The travel history includes the past travel route of the vehicle 13, a travel speed in any section, a time when the vehicle was located at any point on the travel route, etc. The in-vehicle device 12 stores the travel history based on a history of position information of the vehicle 13, a history of the travel speed, etc. in an internal memory, and sends information on the travel history to the server device 10 in response to the request from the server device 10.

In S203, the server device 10 analyzes the travel history of each vehicle 13. The server device 10 determines, based on map information, whether there is a travel history in which the vehicle passes in the vicinity of one or more target objects. The server device 10 prestores information indicating the position of the target object. The vicinity of the target object includes a point that is within any reference distance range from the target object and at which an image of the target object can be captured on a road. The reference distance is preset as desired based on the image capturing performance of the image capturing device 14 of the vehicle 13. Even within the reference distance, blind spots where an image of the target object cannot be captured due to obstacles such as high-rise buildings are excluded from the vicinity of the target object. Such blind spots are derived by any algorithm based on the height of the target object, the distances between the target object and surrounding architectural structures, the heights of the surrounding architectural structures, etc. Information on the target object, the image capturing performance of the image capturing device 14, etc. is set as appropriate by, for example, the operator operating the terminal device 15, and is stored in the server device 10. When a plurality of target objects is set, the vehicle 13 having a travel history of passing in the vicinity may be different for each target.

In S205, the server device 10 selects a vehicle 13 from which a captured image of the target object is to be acquired. The server device 10 selects a vehicle 13 whose travel route passes in the vicinity of the target object. When two or more vehicles 13 can be selected for one target object, the two or more vehicles 13 may be selected, or any one of the vehicles 13 may be selected. When selecting any one of the vehicles 13, it is possible to select, for example, a vehicle 13 that passes in the vicinity of the target object at a lower speed, or a vehicle 13 that has passed in the vicinity of the target object more times. As the speed at which the vehicle passes in the vicinity of the target object decreases or as the number of times the vehicle passes in the vicinity of the target object increases, the possibility of obtaining a higher quality image of the target object increases.

In S206, the server device 10 sends a request for a captured image to the selected vehicle 13. The request for the captured image includes position information corresponding to the vicinity of the target object and an instruction for causing the in-vehicle device 12 to send an image captured in the vicinity of the target object. The request for the captured image may also include an instruction for causing the vehicle 13 to travel at any reference speed in the vicinity of the target object. The reference speed is any speed that is sufficiently low to capture clearer images without interfering with safe traffic.

In S207, the in-vehicle device 12 starts traveling of the vehicle 13 as planned or in response to a user operation. The in-vehicle device 12 periodically acquires the current position of the vehicle 13, and causes the image capturing device 14 to start capturing images at any frame rate.

In S208, the in-vehicle device 12 sends an image captured in the vicinity of the target object to the server device 10. When the current position of the vehicle 13 is within the vicinity of the target object, the in-vehicle device 12 sends the image captured by the image capturing device 14 to the server device 10. Alternatively, the in-vehicle device 12 may store the image captured when the vehicle 13 is located in the vicinity of the target object such that the image can be identified from the other captured images, and send the image to the server device 10 at any timing.

In S209, the server device 10 analyzes the target object in the captured image. Specifically, the server device 10 performs image processing on the captured image using any algorithm, detects the target object, and determines the degree of deterioration of the target object. The degree of deterioration of the target object is determined based on the degree of color distribution that differs from other parts to indicate deterioration of a wall surface, the presence or absence of an image showing cracking, etc. The server device 10 may prestore a determination model generated by machine learning using images of structures associated with degrees of deterioration as training data, and use the determination model to determine the degree of deterioration of the target object in the captured image.

In S210, the server device 10 transmits, to the terminal device 15, the captured image acquired from the in-vehicle device 12 and the result of analysis thereof, that is, information on the result of determination of the degree of deterioration of the target object.

In S211, the terminal device 15 displays the captured image and the analysis result acquired from the server device 10 and presents them to the operator. Thus, the operator can visually recognize the image of the target object and recognize the degree of deterioration of the target object.

Through the above operation of the vehicle control system 1, the selected vehicle 13 is caused to send the image captured in the vicinity of the target object. Therefore, it is possible to provide the operator with the captured image that is highly likely to include the target object without requiring processing such as extraction of the target object from the captured images collected from many other vehicles 13. Thus, it is possible to more efficiently acquire the target captured image from the images captured by the vehicle.

Although the embodiment has been described above based on the drawings and examples, it should be noted that those skilled in the art can easily make various modifications and alterations thereto based on the present disclosure. It should be noted, therefore, that these modifications and alterations are within the scope of the present disclosure. For example, the functions included in each means, each step, etc. can be rearranged so as not to be logically inconsistent, and a plurality of means, steps, etc. can be combined into one or divided.

What is claimed is:

1. An information processing device comprising:
a communication unit configured to communicate with an in-vehicle device; and
a control unit configured to, when determination is made that a travel history of a vehicle indicates that the vehicle passes in a vicinity of a target object, acquire an image captured in the vicinity of the target object from the in-vehicle device of the vehicle, send information indicating a state of the target object to a terminal device, and cause the terminal device to output the information.

2. An information processing device comprising:
a communication unit configured to communicate with a vehicle; and
a control unit configured to, when a travel history of the vehicle indicates that the vehicle passes in a vicinity of a target object, acquire a captured image of the target object from the vehicle, and output information indicating a state of the target object.

3. The information processing device according to claim 2, wherein the control unit is configured to determine, among a plurality of vehicles, a vehicle from which the captured image is to be acquired based on travel histories of the vehicles.

4. The information processing device according to claim 3, wherein the control unit is configured to determine, among the vehicles, the vehicle from which the captured image is to be acquired under a condition that the vehicle travels at a predetermined travel speed.

5. The information processing device according to claim 2, wherein the control unit is configured to send, to the vehicle, an instruction to limit a travel speed of the vehicle.
